(19) United States
(12) Patent Application Publication
(10) Pub. No.: US 2011/0200808 A1
(43) Pub. Date: Aug. 18, 2011

(54) Masking Strip with a PVC Film

(76) Inventors: Bernhard Müssig, Seevetal (DE); Dennis Seitzer, Hamburg (DE)

(21) Appl. No.: 12/995,382

(22) PCT Filed: Dec. 17, 2009
(86) PCT No.: PCT/EP2009/067367

§ 371 Date: Apr. 29, 2011

(30) Foreign Application Priority Data
Dec. 18, 2008 (DE) 10 2008 062 755.0

(51) Int. Cl. C09J 7/02; B32B 27/08; B32B 27/30; B32B 37/12; B32B 37/02

(52) U.S. Cl. 428/220; 428/343; 428/355 BL; 428/355 AC; 428/355 EN; 156/60

(57) ABSTRACT

An adhesive mass that at least contains an acid-anhydride-modified vinyl aromatic block copolymer, a metal chelate, and an adhesive resin for bonding optical components, particularly optical films, wherein the adhesive mass has a transmittance greater than 86% and a haze less than 5%.

This is a 371 of PCT/EP2009/067367 filed 17 Dec. 2009 (international filing date), and claims the priority of German Application No. 10 2008 062 755.0, filed on 18 Dec. 2008.

The present invention relates to a stretchable, self-adhesive masking tape based on plasticized PVC carrier film, especially for the temporary masking (covering) of surfaces prior to further working such as sandblasting or finishing, and for producing patterns such as straight or curved lines, letters or logos.

### BACKGROUND OF THE INVENTION

A self-adhesive masking tape, also referred to below as adhesive masking tape, is to have a number of key properties in order to meet the particular requirements imposed on the tape. Easy stretchability when bonding in curves (that is, a maximum force or tensile strength that is not too high) in conjunction with high modulus of elasticity (estimated by the force at 1% elongation) in the range of the forces which occur during unwind or during application to straight sections, little or no shrinkback tendency in the bonded state, and a low thickness are important main requirements in order to be able to produce a sharply defined and even paint edge on curved surfaces and also to allow a clean bond in curves. In order to prevent shrinking of the extended regions of the adhesive masking tape, of the kind formed in the outer regions in the case of adhesive bonds around narrow curves and also on application to spherical surfaces, the carrier film must reduce these stresses within a short time. This presupposes that the carrier film possesses a high relaxation propensity.

There is likewise a desire on the part of the user for easy hand tearability in application, in order to achieve rapid and easy processing of the adhesive masking tape. A masking tape is expected in particular not to deleteriously influence (damage) either the substrate to be masked, to which it is bonded, nor the paint film to be applied. This means in particular that the substrate, following removal of the masking tape, does not exhibit any discoloration, mechanical deformation or residues of the masking tape (that is, of the adhesive or of the film), since the function of a masking tape is, indeed, to protect the substrate.

To date for this application, adhesive masking tapes with a carrier made of paper, and very occasionally of film, have been used. Paper masking tapes do not generally have any adverse effect on the substrate to be masked or on the paint film to be applied. For small bonding radii, however, they are unsuitable, lacking sufficient stretchability. If highly creped paper is used, it is indeed possible to achieve somewhat smaller radii, but the severe creping gives rise to untidy paint edges. For larger plastic parts such as automobile bumpers, paper masking tapes are unsuitable, since they are not sufficiently yielding when the masked parts undergo a high degree of thermal expansion on passage through a painting oven.

When oriented (stretched) films of polyester, unplasticized PVC, polyethylene or polypropylene are used, the stretchability, as with paper, is inadequate. Unoriented stretchable films of polyolefins such as polyethylene or propylene copolymers are not hand tearable. In the case of bonding in curves, moreover, after stretching, they exhibit a shrinkback, particularly at relatively high application temperatures. Plasticized PVC carrier films, in contrast, are able to reduce shrink-producing stresses in the course of heating, but contain a large number of raw materials which are capable of migrating and which may damage the substrate. Advancing technological improvements in automobile finishing have increased the sensitivity with respect to damage due to masking tapes. This is the case particularly for high-gloss finishes.

Adhesive tapes based on plasticized PVC films are described in GB 2,171,712 A1, for example. Plasticized PVC adhesive tapes of this kind include a PVC homopolymer along with about 36 to 52 phr of a monomer plasticizer (generally phthalate-based), and are used as insulating tapes. By phr (parts per hundred resin) is meant—and this applies to the whole of the disclosure—parts by weight of an additive per 100 parts by weight of PVC polymer. These plasticized PVC adhesive tapes typically have a high toughness, tensile strength, and elongation at break, and so tearing the adhesive masking tape without tools such as scissors or knives is difficult to achieve, and yet the user desires an easy hand tearability in application, similar to that with a paper masking tape. A particular serious disadvantage are residues of adhesive, as a result of softening of the pressure-sensitive adhesive due to migratable plasticizers such as dioctyl phthalate or diisononyl phthalate, especially if the adhesive tape has been heated in a painting oven prior to its removal. The relatively high force at 1% elongation leads to significant stretching of the product on unwind, and hence to an increased shrinkback.

If, instead of monomer plasticizer, a low-migration polymer plasticizer is used in an amount of 30 phr or less, the masking tape is hand tearable, but is so brittle that tears occur very frequently in production of the film and during removal of the masking tape.

State of the art are adhesive masking tapes with a PVC film comprising a conventional PVC polymer and a polymer plasticizer, with an amount of more than 40 phr, and a barium-cadmium stabilizer. Although these adhesive masking tapes do not have a propensity toward plasticizer-induced residues, they are nevertheless even more difficult to tear than films with monomer plasticizer. Furthermore, on account of their high shrinkback propensity, these adhesive masking tapes are unsatisfactory in application on highly curved surfaces and in bonds on curves with a narrow radius. At elevated temperatures in the paint baking operation, as a result, the parting of the adhesive masking tape from depressions and beads, and also its lifting from stretched edges in curves, are observed. This results in paint underruns and in untidy paint edges, and also in residues of adhesive that have sheared off at the ends of the adhesive tape (at the places where the adhesive tape has withdrawn due to shrinkage).

Combinations of polymer plasticizer and monomer plasticizer are known for PVC insulating tapes for high-temperature insulating applications. At an amount of 5 phr of monomer plasticizer or more, residues of adhesive may occur. With plasticizer combinations of this kind, moreover, the problems caused by polymer plasticizers are encountered.

Referred to below are two patent publications which describe masking tapes with polymer plasticizer and with barium-zinc stabilizer that are said to feature enhanced mechanical properties. The stabilizer used in each case, Baerostab UBZ 639, like the other standard commercial barium-zinc stabilizers, includes considerable amounts of phosphite. In general this is tris(nonylphenyl) phosphite, which as a CMR raw material will no longer be allowed to be used in the EU in the future. Phosphites may, as has been found, cause ghosting on the masked substrate, and ought therefore to be avoided. By ghosting is meant that, when observed at a narrow angle against a light source, the surface where bonding was previously present is observed to have residues which, although not tacky, are visually perceptible. Ghosting is especially apparent on dark finish substrates.

EP 1 626 074 A1 describes masking tapes having good hand tearability through the use of PVC with a very low K value. A PVC of this kind with low molecular weight reduces the mechanical strength of the film to such an extent that the technical implementation founders in frequent instances of tearing of the film on takeoff from the calender.

The essential idea of EP 1 362 881 A1 is the addition of a polymer which is incompatible with PVC or is crosslinked, for the purpose of achieving better hand tearability. Given appropriate formulation of film and adhesive, it is possible to prevent larger residues on conventional synthetic resin top coats (in the case of two-coat finishing). On more recent one-coat finishes, however, ghosting occurs. It has been found that this is caused by a phosphite component of the Baerostab UBZ 639 stabilizer which is used in both patent publications. On less critical finishes or at lower baking temperatures, even a phosphite-containing stabilizer may be free from ghosting, or, at least, the ghosting is readily removable by wiping with a solvent-soaked cloth.

### SUMMARY OF THE INVENTION

It is an object of the invention to provide an adhesive masking tape with a PVC-based carrier material that causes no residues of adhesive and no ghosting when the adhesive masking tape on the paint film to be protected is subjected to a thermal load in the painting oven and is then removed at room temperature.

The carrier material of the adhesive masking tape is intended, furthermore, to exhibit a low initial stretchability (under forces of unwind and application) in conjunction with ready deformability with low shrinkback tendency and with easy hand tearability.

This object is achieved by means of an adhesive masking tape as described hereinbelow. The invention further embraces possibilities for use of the adhesive masking tape of the invention.

### DETAILED DESCRIPTION

The invention accordingly provides an adhesive masking tape comprising a PVC carrier material (film) in web form and a coating of pressure-sensitive adhesive applied thereto on one side, where the carrier material comprises the following constituents:
a) a PVC polymer having a K value of 58 to 90, preferably 65 to 80, more preferably 70 to 80,
b) 20 to 55 phr of plasticizer, preferably polymer plasticizer, and
c) 0.2 to 8 phr, preferably 1 to 5 phr, of a phosphite-free PVC stabilizer.

Surprisingly and unforeseeably for the skilled person, an adhesive masking tape of this kind is able to achieve the stated objects.

Conventional PVC stabilizers include compounds of lead such as, for example, tribasic lead sulfate, or of cadmium, such as cadmium stearate or cadmium octoate, for example. They comprise in some cases an addition of phosphite such as lead phosphite. In future, however, they will no longer correspond to the heightened environmental requirements.

Dibutyltin stabilizers are used for the production of unplasticized PVC films, for adhesive packaging tapes, for example, but are not usual with plasticized PVC films. They do not have an addition of phosphite. As a disadvantage, they have an unpleasant odor in the finished product. As so-called CMR raw materials, the use of tin stabilizers is being restricted as part of REACh (EU chemicals ordinance). Generally speaking, and in the past, dibutyltin stabilizers are and have been used that in future will no longer be able to be used at all.

In the case of polyurethane clear coats (top coats on the color coats), masking tapes with tin stabilizers lead to finishing defects. In the area surrounding the adhesive masking tape, the applied polyurethane paint acquires a surface texture resembling that of orange peel. It is thought that the stabilizer undergoes evaporation and, in the surrounding area, acts as a crosslinking catalyst on the curing polyurethane paint.

In accordance with the invention, therefore, preference is given to stabilizers which not only contain no phosphite but are also preferably free from lead, cadmium or tin, or free from lead and cadmium, and preferably free from tin as well. Particularly preferred are stabilizers based on calcium and zinc. Organic, phosphite-free stabilizers are suitable in principle, but experience with them to date in plasticized PVC is minimal, and their environmental assessment is still not conclusive. The use of epoxidized fatty acid derivatives such as epoxidized soyabean oil as a costabilizer is possible, but the amount should be limited or they should be avoided, on account of the migration tendency, in the same way as for the monomer plasticizers.

The carrier preferably has a monomer plasticizer content of less than 5 phr, preferably less than 1 phr, which reduces the risk of residues of adhesive due to cohesive fracture. Examples of monomer plasticizers are DOP, DINP, DIDP, and TOTM.

In order to obtain the desired softness on the part of the film it is possible to use soft polymers that can be blended with PVC, such as, for example, chlorinated polyethylene (for example, Tyrin from Dow) nitrile-butadiene rubber (NBR with high AN content), polyurethane (for example, Baymod PU, Lanxess), acrylate (for example, Paraloid KM334, Rohm & Haas), EVA (Levapren/Levamelt, Lanxess), ethylene-vinyl acetate-carbon monoxide terpolymer (Elvaloy, DuPont) or ABS (for example, Baymod A 90, Lanxess).

It is preferred to use what is called a polymer plasticizer with a low migration tendency. In the text below, the term polymer plasticizer will be used more particularly for liquid polyesters formed from at least one dicarboxylic acid and at least one diol. Examples of such are condensates of adipic, sebacic, azelaic or phthalic acid and butane-1,4-diol or hexane-1,6-diol. In the present invention, plasticizers based on adipic acid and butanediol have proven particularly suitable. Examples here include Palamoll 652 (BASF), Globinex W 2050 (DIC), and Uraplast RA 19 (DSM).

The amount of polymer plasticizer is preferably between 15 and 35 phr, more preferably between 15 and 33 phr. If no other plasticizer is used, the amount is preferably between 25 and 35 phr, more preferably between 20 and 30 phr.

Barium-zinc stabilizers and calcium-zinc stabilizers typically comprise phosphites. They have a multiple function: as an antioxidant, as an acid scavenger, and for addition to polyenes in order to prevent further degradation of PVCs that have already been damaged. When phosphite-free stabilizers are used, it is possible, under a high thermal load, that the oxidation stability will no longer be sufficient, since phosphites, alongside other functions, also act as an antioxidant. Therefore, preferably, phosphite-free antioxidants are used as well. These may be added to the formula or else are already part of a completed stabilizer product.

Examples (in place of the IUPAC name, the CAS numbers are cited):

### Phenolic Function:

### CAS 6683-19-8, 2082-79-3, 1709-70-2, 36443-68-2, 1709-70-2, 34137-09-2, 27676-62-6, 40601-76-1, 31851-03-3, 991-84-4

### Sulfur-Containing Function:

### CAS 693-36-7, 123-28-4, 16545-54-3, 2500-88-1, 16545-34-3, 29598-76-3

### Phenolic and Sulfur-Containing Function:

### CAS 41484-35-9, 90-66-4, 110553-27-0, 96-96-5, 41484

Since thioethers likewise have a tendency toward ghosting, it is particularly preferred to use sulfur-free phenolic antioxidants. In this context, CAS 6683-19-8 (for example, Irganox 1010) and 2082-79-3 (for example, Irganox 1076) have emerged as being particularly suitable.

Suitable PVC base materials for the films include emulsion PVC, bulk PVC, and more particularly suspension PVC with high porosity. By the PVC polymer is meant, primarily, a homopolymer. PVC polymers with a comonomer such as vinyl acetate are not excluded, but are of little practical interest on account of the higher costs. Standard suspension PVC polymers with a suitable K value are, for example, Solvin 264PV, Solvin 271GA (Solvin GmbH) or Vinnolit S 3160 or Vinnolit S 4080 (Vinnolit GmbH). Through the combination of different K values it is possible to ensure that the component with the highest K value does not gel completely, and takes on the function of a filler which promotes hand tearability.

Where a part of the PVC is in crosslinked form, such as the matting agent Vinnolit K 221, for example, it is not plasticizable, but instead acts only as a filler and is therefore not counted when calculating the amount of PVC on which the phr of the additives are based.

The PVC may be present not only as a homopolymer, but also, wholly or partly, as a graft polymer, such as, for example, Vinnolit VK 801 (ethylene-vinyl acetate copolymer grafted with vinyl chloride) or Vinnolit K 707 E (ethylene-acrylate copolymer grafted with vinyl chloride). Where graft polymers of this kind are used, the amount of graft base should be assigned to the plasticizer, and the amount of vinyl chloride to the PVC, within the meaning of the claims. In the case of Vinnolit VK 801, therefore, 50% by weight is assigned to the plasticizer, and 50% by weight to the PVC. On account of the high toughness, graft polymers of this kind are not ideal as the sole plasticizer for masking applications, but they are suitable for applications where a high toughness is required, such as for adhesive antistonechip tapes, for example.

The present subject matter of the invention preferably has a total amount of soft components (polymer plasticizer, monomer plasticizer, soft, PVC-miscible polymer, and the soft fraction in a graft polymer) of 25 to 40 phr, preferably 30 to 40 phr.

Further processing assistants are lubricants (for example, stearic acid, stearates, PE waxes and oxidized PE waxes), and dispersants (for example, Paraloid K 120 ND, Rohm & Haas). Lubricants are frequently also present in the stabilizer products. At the selection stage, it should be ensured that the lubricant does not give rise to any ghosting.

Further polymers or additives that are customary in PVC films, such as fillers, pigments, flame retardants or matting agents, may be used for producing the carrier film of the adhesive masking tape of the invention. Examples of fillers are calcium carbonate (chalk, limestone, marble, precipitated chalk), kaolin, and silica. Their function is to set processing properties and to set the mechanical data of the film, and also to obtain costs more favorably. One example of a matting agent is crosslinked PVC for example Vinnolit K221, it serves simultaneously for improving the hand tearability.

Through inorganic or organic pigments such as, for example, carbon black, titanium dioxide, nickel titanate or chromium oxide it is possible to set a defined color.

The masking tape has optimum properties if, furthermore, the carrier material has
a tensile strength at 1% strain of at least 3 N/cm, preferably at least 5.5 N/cm,
a thickness below 130 μm, preferably below 100 μm,
a tensile strength of 12 to 30 N/cm, and/or
an elongation at break in the range from 200% to 350%.

The film can be produced by the usual method. The components may be processed in an extruder or dry blender with downstream internal mixer and storage roll mechanism.

It is found that a short mixing time promotes hand tearability and cutability, and that an excessive or uncontrolled mixing time, when using internal mixers and storage roll units, for example, impairs the hand tearability or makes the hand tearability inconsistent. For producing the film for the masking tape of the invention, therefore, a continuous process is preferred, especially planetary roller extruders and twin-screw extruders (Buss pin extruders, for example). By this means it is possible to set the degree of gelling reproducibly. The melt may optionally be filtered in a strainer. The process of primary suitability for the production of the carrier material for the masking tape of the invention is that of calendering, since by such a process the film exhibits a lower shrinkage tendency than in the case of extrusion. As a result, a shrinkage in longitudinal direction of less than 3% can be achieved. For this purpose it is sensible to optimize the annealing section between calender takeoff and winding, in respect of temperature profile and speed profile. For the calendering of the film of the invention, an inverted-L calender is especially suitable. Embossing the film is possible for the purpose of adjusting the unwind force or for the sensorial impression.

The PVC film is provided on one side with a coating of adhesive (pressure-sensitive adhesive, self-adhesive). Polyisoprene, polyisobutylene, and acrylate adhesives are suitable more particularly as the coating of adhesive for the adhesive masking tape. Application may take place by coating from solution, dispersion or the melt, or as a prepolymer to be cured. Crosslinking is advantageous for residue-free removability of the adhesive masking tape following application, and may be accomplished chemically (for example, crosslinkers such as isocyanates or alkylphenol resins) or by irradiation (with UV light or electron beams, for example). The shear strength is likewise improved as a result, thereby increasing the storage stability of narrow rolls and avoiding residues of adhesive as a result of shearing-off in the paint drying operation. Crosslinking may take place during the production of the masking tape or during application (for example, by chemical or thermal post vulcanization in the coating oven). Crosslinking ought to be sufficiently high to allow residue-free removal of automotive paints following thermal exposure at 160° C. In order to ensure sufficient adhesion but also ease of unwind, plus redetachability after application, the bond strength to steel ought to be in the range from 1.6 to 4.8 N/cm, preferably 2 to 3 N/cm.

In accordance with the invention, the masking tape is furnished with a well-adhering pressure-sensitive adhesive, so that the forces occurring as a result of deformation, heating, paint (solvent) treatment or sandblasting do not result in the detachment (peeling) or shearing of the masking tape.

If desired it is possible for a varnish to be applied to the reverse of the carrier material, in other words to the side opposite the adhesive coating side, for the purpose of facilitating (enhancing) unwindability. This reverse-face coating, however, must not detract from the excellent adhesion of primers and paints to the reverse face of the carrier film.

Advantage attaches to the use of a primer layer between carrier film and adhesive for the purpose of promoting the adhesion of the adhesive to the film and hence the residue-free removability after application.

The self-adhesive masking tape of the invention is generally in the form of a strip, but includes shaped templates (for example, diecuts or precuts). It may be provided with a reverse-face liner (for example, release film or silicone paper) and/or with an application tape (for example, film adhering weakly to the facing side, for stabilizing and transferring the template(s) to the substrate). The adhesive masking tape of the invention may also be used for specialty applications requiring increased tensile strength and extremely low stretchability (high force at 1% strain). Products of such kind are used, for example, for masking window flanges of vehicles during the painting process. For this purpose, prior to application, the masking tape is laminated together with a further adhesive tape, or the PVC film of the invention is laminated with a further film before being coated with adhesive. Components of this kind for lamination are composed preferably of polyester or of impregnated paper. For this application, hand tearability is of minor importance, provided that the masking tape can be severed by an automatic applicator without disruption.

The general expression “adhesive tape” for the purposes of this invention encompasses all sheetlike structures such as two-dimensionally extended films or film sections, tapes with extended length and limited width, tape sections, and the like, and also, finally, diecuts or labels.

At the subsequent coating stage, the film ought not to be stretched by excessive tensile forces. If produced well, the masking tape of the invention requires no measure to prevent telescoping (deformation on storage). For rolls having a width of 2 to 8 mm, however, it is sensible to manufacture jumbo rolls and to reduce the stresses by heat treatment in an oven. Slitting takes place in accordance with the methods that are customary for PVC adhesive tapes, such as knife, shear, crush, score or razor slitting. Since the design of the film gives it outstanding hand tearability, improving the tear behavior by means of suitable slitting techniques, though possible, is generally unnecessary.

The masking tape of the invention is suitable for painting and sandblasting, especially for masking during the painting of vehicles and parts of vehicles. Even after a thermal load of 160° C., the adhesive masking tape of the invention, given appropriate formulation of film and adhesive, can be detached from the paint surface without residue and without tearing.

The masking tape of the invention is intended more particularly for vehicles such as, for example, automobiles, or for parts thereof, such as bumpers, motorcycle tanks, etc., in the finishing operation. It is used for producing sharply defined paint edges and on the basis of the low shrinkback tendency (relaxation) of the carrier film is particularly suitable for application on highly curved surfaces and for bonding around very narrow curves. The masking tape of the invention is notable for leaving no residues, not even ghosting, on masked, critical finish surfaces, even after high thermal load.

### Test Methods

The measurements are carried out—unless expressly stated otherwise—under test conditions of 23±1° C. and 50±5% relative humidity. All tensile tests take place on test specimens cut out in longitudinal direction.

The K value of PVC is determined in accordance with DIN 53726/ISO 1628-2.

The thickness of the film is determined in accordance with DIN 53370. When a masking tape is tested, the layer of pressure-sensitive adhesive is removed prior to measurement.

The tensile stretch behavior of the adhesive masking tape is determined on type 2 test specimens (15 cm wide and 150 cm long test strips, clamped-in length 100 mm) in accordance with DIN EN ISO 527-3/2/300, with a testing speed of 300 mm/min.

The tensile force at 1% elongation (F1% value) is determined on a 15 mm wide and 150 mm long test strip (clamped-in length 100 mm) in accordance with DIN EN ISO 527-3/2/10, with a testing speed of 10 mm/min.

### Evaluation of Hand Tearability:

(++) very easy,
(+) easy,
(−) difficult,
(−−) very difficult.

The shrinkage in longitudinal direction is determined in accordance with DIN 53377 (30 min at 80° C., 10 cm times 10 cm, free-hanging).

The bond strengths are determined with a peel angle of 180° in accordance with AFERA 4001 on test strips 15 mm wide. Here, standardized steel plates are used as the test substrate.

For the visual evaluation of the residues or ghosting, in examples 1 to 8 and comparative examples 1 to 8, adhesive masking tapes 15 mm wide are adhered to a metal panel painted with synthetic-resin test paint (KH bodywork top coat VWL 041, ivory black, BASF coatings), and then are stored at 160° C. for 30 minutes. After subsequent cooling to 25° C., the adhesive masking tape is pulled from the paint surface at an angle of 180° and at a speed of 1000 mm/min. This is followed by a visual assessment of the residues on the paint surface at a flat angle against a light source, in accordance with the following criteria:

(++) no residues and no ghosting;
(+) ghosting barely visible;
(−) ghosting or residues of adhesive;
(−−) severe residues of adhesive, or transfer of the adhesive.

In examples 5 to 8 and in comparative examples 5 to 8, adhesive masking tapes 15 mm wide are adhered to a metal panel painted with a one-coat bodywork paint (1-K-konventionell-uni FD07-9103, Audi, curing at 160° C., 30 minutes) and then stored at 160° C. for 60 minutes. After subsequent cooling to 25° C., the adhesive masking tape is pulled from the paint surface at an angle of 180° and at a speed of 1000 mm/min. This is followed by visual assessment of the residues on the paint surface at a flat angle against a light source, in accordance with the criteria above.

The invention will be elucidated in more detail below with reference to a number of examples, without wishing to restrict the invention in any way at all with these examples.

Also given are comparative examples, which underline the outstanding properties of the masking tape of the invention.

The following sections are treated:
Tabular compilation of the raw materials used for the PVC film
Description of the examples
Tabular compilation of the results of the examples
Description of the comparative examples
Tabular compilation of the results of the comparative examples

TABLE 1
Compilation of the raw materials used for the PVC film (for
measurement conditions and units, see Test Methods)

| Raw material | Manufacturer | Description | Technical data |
|---|---|---|---|
| Solvin 265 PC | Solvin | PVC homopolymer | K value 65 |
| Solvin 258 RF | Solvin | PVC homopolymer | K value 58 |
| Solvin 271 GA | Solvin | PVC homopolymer | K value 71 |
| Vinnol S 4080 | Vinnolit | PVC homopolymer | K value 80 |
| Vinnolit S 3160 | Vinnolit | PVC homopolymer | K value 60 |
| Vinnolit VK 801 | Vinnolit | Vinyl chloride | 50% by weight VC |
| | | grafted onto | 50% by weight |
| | | ethylene-vinyl | EVA |
| | | acetate | |
| Palamoll 652 | BASF | Polymer | Polyadipate |
| | | plasticizer | |
| Palatinol N | BASF | Monomer | Diisononyl |
| | | plasticizer | phthalate |
| Palatinol AH | BASF | Monomer | Dioctyl |
| | | plasticizer | phthalate |
| Globinex W 2050 | DIC | Polymer | Polyadipate |
| | | plasticizer | |
| Omyalene G 200 | Omya | Filler | Chalk |
| Omya EHX1 | Omya | Filler | Chalk |
| Bukit Batu Murah | Toko | Filler | Chalk |
| | Malaysia | | |
| Vinnolit K 221 | Vinnolit | Matting agent | Crosslink PVC |
| | | | powder |
| Kronos 2160 | Kronos | Titanium dioxide | Rutile |
| Baerostab | Baerlocher | PVC stabilizer | Ba—Zn type |
| UBZ 731 X | | | without |
| | | | phosphite |
| Baerostab 639 | Baerlocher | PVC stabilizer | Ba—Zn type with |
| | | | phosphite |
| Baeropan | Baerlocher | PVC stabilizer | Ca—Zn type |
| MC 8890-KA/2 | | | without |
| | | | phosphite |
| Baerostab CT | Baerlocher | PVC stabilizer | Ca—Zn type with |
| 9073 | | | phosphite |
| Baerostab LSA | Baerlocher | PVC costabilizer | ESO |
| Mark 17 MOK S | Akcros | PVC stabilizer | Dioctyltin type |
| | | | without |
| | | | phosphite |
| Mark 17 M | Akcros | PVC stabilizer | Sn type without |
| | | | phosphite |
| DHT 4A | Kyowa | PVC costabilizer | Synthetic |
| | | | hydrotalcite |
| Irganox 1010 | Ciba | Antioxidant | CAS 6683-19-8 |
| Micranyl B3RS-NQ | Ciba | Pigment | Yellow |
| Baerocid L-1A | Baerlocher | Process | Lubricant |
| | | auxiliary | (Stearic acid) |
| Hostanox PAR 24 | Clariant | Antioxidant and | Tris(2,4-di- |
| | | costabilizer | tert-butyl) |
| | | | phosphite |
| Paroloid K 120 | Rohm & Haas | Process | Polyacrylate |
| ND | | auxiliary | |
| Elvaloy 741 | DuPont | Ethylene-vinyl | T_{cr} = 66° C. |
| | | acetate co- | |
| | | terpolymer | |
| Levapren 600 HV | Lanxess | Ethylene-vinyl | 60% by weight |
| | | acetate | vinyl acetate, |
| | | copolymer | amorphous, |
| | | | δ 8.84 cal^{1/2}/cm^{3/2} |

### EXAMPLES

### Example 1

The carrier film is produced by first preparing, in a high-speed mixer, a dry blend of

| | | |
|---|---|---|
| 50 | phr | Vinnolit S 3160, |
| 50 | phr | Vinnolit S 4080, |
| 27 | phr | Palamoll 652, |
| 9.4 | phr | Omya EHX1, |
| 4 | phr | Baeropan MC 8890-KA/2, |
| 1.5 | phr | Paraloid K 120 ND, |
| 1.8 | phr | Micranyl B3RS-NQ and |
| 3 | phr | Kronos 2160. |

The mixture is cooled to 60° C. and then 10 phr of Elvaloy 741 are added. This dry blend is subsequently plastified in a planetary roller extruder at 180° C. and shaped using an inverted-L calender to give a film having a width of 1500 mm and a thickness of 0.085 mm. The carrier film thus obtained is coated with an adhesion promoter layer, consisting of a solution of 1 part of natural rubber and 1 part of nitrile rubber in toluene, with a coatweight of 0.6 g/m², and dried. The adhesive coating is applied directly to the adhesion promoter coat, using a comma bar, with a coatweight of 25 g/m². The adhesive consists of a solution of a natural rubber adhesive in benzine with a solids content of 30% by weight.

This adhesive is composed of

| | | |
|---|---|---|
| 50 | parts | natural rubber, |
| 10 | parts | zinc oxide, |
| 3 | parts | rosin, |
| 6 | parts | alkylphenol resin, |
| 17 | parts | terpene-phenolic resin, |
| 12 | parts | poly-β-pinene resin, and |
| 2 | parts | mineral oil. |

The final coat is dried in a tunnel at 70° C. Testing takes place in accordance with table 2.

### Example 2

In the same way as in example 1, a carrier film is produced from the following components:

Dry blend of

| | | |
|---|---|---|
| 50 | phr | Vinnolit S 3160, |
| 50 | phr | Vinnolit S 4080, |
| 28 | phr | Palamoll 652, |
| 9.4 | phr | Omya EHX1, |
| 4 | phr | Baerostab UBZ 731 X, |
| 1.5 | phr | Paroloid K 120 ND, |
| 1.8 | phr | Micranyl B3RS-NQ and |
| 3 | phr | Kronos 2160. |

The mixture is cooled to 60° C. and then 10 phr of Elvaloy HP 441 are added. Further processing takes place as in example 1.

### Example 3

In the same way as in example 1, a carrier film is produced:

The dry blend of

| | | |
|---|---|---|
| 80 | phr | Solvin 271 GA, |
| 20 | phr | Solvin 265 PC, |
| 29 | phr | Globinex W 2050, |
| 18 | phr | Omyalene G 200, |
| 1.8 | phr | Micranyl B3RS-NQ, |
| 3 | phr | Kronos 2160, |
| 3 | phr | Mark 17 M, |
| 0.3 | phr | Irganox 1010, |
| 0.15 | phr | Baerocid L-1A, |
| 1.5 | parts by weight | Paraloid K 120 ND |
| | | is admixed with 15 phr Levapren 600 HV. |

The film is primed with a 20% strength solution of Desmolac (polyurethane resin from Lanxess) in butanone (dry coatweight 0.6 g/m²). Using a comma bar, 25 g/m² of acrylate adhesive are applied. The adhesive has an acrylate polymer content of 40% by weight and contains 0.3% by weight Desmodur L (isocyanate crosslinker) in toluene. The acrylate copolymer is composed of 90% by weight butyl acrylate and 10% by weight hydroxyethyl acrylate.

Even after a heat treatment at 170° C. for 60 minutes, the masking tape can be removed without residues. If the partially masked metal test panel is repainted with a colorless polyurethane automotive top coat and the article under test is then placed in the oven, it is observed, following removal, that the paint surface is corrugated in the close vicinity of the masking tape. This is not the case when a similar procedure is employed with the preceding examples.

### Example 4

The carrier film comprises the following components:

| | | |
|---|---|---|
| 70 | phr | Solvin 271 GA, |
| 20 | phr | Solvin 258 RF, |
| 20 | phr | Vinnolit VK 801, |
| 26 | phr | Globinex W 2050, |
| 10 | phr | Bukit Batu Murah, |
| 1.8 | phr | Micranyl B3RS-NQ, |
| 3 | phr | Kronos 2160, |
| 0.2 | phr | Irganox 1010, |
| 3 | phr | calcium aluminum hydroxyfumarate (Ca₄Al₂ |
| | | (OH)₁₂C₄H₂O₄), |
| 0.5 | phr | zinc stearate, |
| 1 | phr | calcium stearate, |
| 1.5 | phr | Paraloid K 120 ND. |

Film production and coating take place in the same way as in example 1.

Prior to winding, however, the side coated with adhesive is lined with a single-sidedly PE-coated and siliconized paper with a basis weight of 120 g/m².

The masking tape is cut into templates using a cutting plotter. Following the removal of the silicone paper, these templates are adhered to a glass sheet and to a marble ball with a diameter of 20 cm. The specimens are sandblasted until the first holes appear in the masking tape. In both cases there is no detachment from the substrate observed.

TABLE 2
Properties of examples 1 to 4

| | Example 1 | Example 2 | Example 3 | Example 4 |
|---|---|---|---|---|
| Thickness [μm] | 85 | 90 | 85 | 85 |
| Force at break [N/cm] | 24 | 25 | 26 | 31 |
| Elongation at break [%] | 280 | 250 | 235 | 325 |
| Force at 1% elongation | 6 | 6 | 5 | 6 |
| [N/cm] | | | | |
| Shrinkage [%] | 2.5 | 3.0 | 2.0 | 3.5 |
| Hand tearability | ++ | ++ | ++ | + |
| Bond strength to steel | 2.4 | 2.3 | 2.2 | 2.3 |
| [N/cm] | | | | |
| Visual assessment | ++ | ++ | ++ | ++ |

### Example 5

The carrier film is produced by first preparing, in a high-speed mixer, a dry blend of

| | | |
|---|---|---|
| 50 | phr | Vinnolit S 3160, |
| 50 | phr | Vinnolit S 4080, |
| 27 | phr | Palamoll 652, |
| 10 | phr | Omya EHX1, |
| 4 | phr | Baeropan MC 8890-KA/2, |
| 1.5 | phr | Paraloid K 120 ND, |
| 1.8 | phr | Micranyl B3RS-NQ and |
| 3 | phr | Kronos 2160. |

The mixture is cooled to 60° C. and then 10 phr of Elvaloy 741 are added. This dry blend is subsequently plastified in a planetary roller extruder at 180° C. and shaped using an inverted-L calender to give a film having a width of 1500 mm and a thickness of 0.085 mm. The carrier film thus obtained is coated with an adhesion promoter layer, consisting of a solution of 1 part of natural rubber and 1 part of nitrile rubber in toluene, with a coatweight of 0.6 g/m², and dried. The adhesive coating is applied directly to the adhesion promoter coat, using a comma bar, with a coatweight of 25 g/m². The adhesive consists of a solution of a natural rubber adhesive in benzine with a solids content of 30% by weight.

This adhesive is composed of

| | | |
|---|---|---|
| 50 | parts | natural rubber, |
| 10 | parts | zinc oxide, |
| 3 | parts | rosin, |
| 6 | parts | alkylphenol resin, |
| 17 | parts | terpene-phenolic resin, |
| 12 | parts | poly-β-pinene resin, and |
| 2 | parts | mineral oil. |

The final coat is dried in a tunnel at 70° C. Testing takes place in accordance with table 3.

### Example 6

In the same way as in example 5, a carrier film is produced, from the following components:

| | | |
|---|---|---|
| 100 | phr | Vinnolit S 3160, |
| 4 | phr | Vinnolit K 221, |
| 31 | phr | Palamoll 652, |
| 15 | phr | Omya EHX1, |
| 4 | phr | Baerostab UBZ 731 X, |
| 1.5 | phr | Paroloid K 120 ND, |
| 1.8 | phr | Micranyl B3RS-NQ and |
| 3 | phr | Kronos 2160. |

The carrier film is coated with an adhesion promoter layer, consisting of a solution of Desmolac (Bayer) in toluene, with a coatweight of 0.6 g/m², and dried. The adhesive coating is applied directly to the adhesion promoter coat, using a comma bar, with a coatweight of 25 g/m². The adhesive is composed of a solution of an acrylate adhesive in toluene with a solids content of percent by weight. This adhesive consists of 0.3 part by weight isocyanate and also of a copolymer of 90 parts by weight n-butyl acrylate and 10 parts by weight hydroxyethyl acrylate. The final coat is dried in a drying tunnel at 70° C.

No ghosting or other residues are observed on the paint surface, even with paint baking temperatures of 170° C.

### Example 7

In the same way as in example 5, a carrier film is produced, from the following components:

| | | |
|---|---|---|
| 100 | phr | Vinnolit S 3160, |
| 29 | phr | Globinex W 2050, |
| 17 | phr | Omyalene G 200, |
| 1.8 | phr | Micranyl B3RS-NQ, |
| 3 | phr | Kronos 2160, |
| 3 | phr | Mark 17 MOK S, |
| 0.3 | phr | Irganox 1010, |
| 0.15 | phr | Baerocid L-1A, |
| 1.5 | phr | Paraloid K 120 ND. |

Coating takes place in the same way as in example 6.

The masking tape can be removed without ghosting from the 1-coat test paint. Where the partially masked metal test panel is recoated with a conventional colorless polyurethane automotive top coat, and the test article is then placed in the oven, it is observed, after removal, that the surface of the colorless top coat is corrugated in the close vicinity of the masking tape. This is not the case when a similar procedure is applied in the case of the preceding examples.

### Example 8

The carrier film comprises the following components:

| | | |
|---|---|---|
| 90 | phr | Solvin 265 PC, |
| 20 | phr | Vinnolit VK 801, |
| 4 | phr | Vinnolit K 221, |
| 26 | phr | Globinex W 2050, |
| 12 | phr | Bukit Batu Murah, |
| 1.8 | phr | Micranyl B3RS-NQ, |
| 3 | phr | Kronos 2160, |
| 0.2 | phr | Irganox 1010, |
| 3 | phr | DHT 4, |
| 0.5 | phr | zinc stearate, |
| 1 | phr | calcium stearate, |
| 1.5 | phr | Paraloid K 120 ND. |

Film production and coating take place in the same way as in example 5.

The masking tape can be removed without ghosting from the 1-coat test paint.

Prior to winding the side coated with a part of the specimen on the adhesive is lined with a single-sidedly PE-coated and siliconized paper with a basis weight of 120 g/m². The masking tape is cut into templates using a cutting plotter. Following the removal of the silicone paper, these templates are adhered to a glass sheet. The specimens are sandblasted until the glass plate has become matt, before the masking tape shows the first holes.

TABLE 3
Properties of examples 5 to 8

| | Example 5 | Example 6 | Example 7 | Example 8 |
|---|---|---|---|---|
| Thickness [μm] | 85 | 95 | 80 | 95 |
| Force at break [N/cm] | 24 | 19 | 24 | 18 |
| Elongation at break [%] | 280 | 220 | 255 | 225 |
| Force at 1% elongation | 6 | 6 | 6 | 6 |
| [N/cm] | | | | |
| Shrinkage [%] | 2.5 | 3.0 | 3.0 | 3.5 |
| Hand tearability | ++ | ++ | ++ | + |
| Bond strength to steel | 2.4 | 2.1 | 2.2 | 2.6 |
| [N/cm] | | | | |
| Visual assessment | ++ | ++ | ++ | ++ |

### COMPARATIVE EXAMPLES

### Comparative Example 1

In the same way as in example 1, a carrier film consisting of

| | | |
|---|---|---|
| 100 | phr | Solvin 265 PC, |
| 40 | phr | Palatinol AH, |
| 10 | phr | Omya EHX1, |
| 4 | phr | Baerostab CT 9073, |
| 3 | phr | Baerostab LSA, |
| 1.8 | phr | Micranyl B3RS-NQ and |
| 3 | phr | Kronos 2160 |

is produced and is coated with an adhesion promoter coat and also with adhesive. The adhesive masking tape becomes stretched considerably even during unwind, and so a considerable shrinkage tendency is observed. Following detachment of the adhesive tape from the paint, wholesale transfer of adhesive is observed.

### Comparative Example 2

In the same way as in example 1, a carrier film consisting of

| | | |
|---|---|---|
| 100 | phr | Solvin 258 RF, |
| 20 | phr | Palamoll 652, |
| 1.5 | phr | Palatinol N, |
| 18 | phr | Omya EHX1, |
| 6 | phr | Baerostab UBZ 639, |
| 4 | phr | Baerostab LSA, |
| 1.5 | phr | Paraloid K 120 ND, |
| 1.8 | phr | Micranyl B3RS-NQ and |
| 3 | phr | Kronos 2160 |

is produced and is coated with an adhesion promoter coat and also with adhesive. Following detachment of the adhesive tape from the paint, ghosting is observed.

### Comparative Example 3

In the same way as in example 1, a carrier film consisting of

| | | |
|---|---|---|
| 50 | phr | Vinnolit S 3160 |
| 50 | phr | Vinnolit S 4080, |
| 27 | phr | Palamoll 652, |
| 9.4 | phr | Omya EHX1, |
| 4 | phr | Baeropan MC 8890-KA/2, |
| 2 | phr | Tris(nonylphenyl) phosphite, |
| 1.5 | phr | Paraloid K 120 ND, |
| 1.8 | phr | Micranyl B3RS-NQ and |
| 3 | phr | Kronos 2160 |

is produced, and coating takes place with an adhesion promoter coat and also with adhesive. Following detachment of the adhesive tape from the paint, very severe ghosting is observed.

### Comparative Example 4

A specimen is produced in the same way as in comparative example 3, but with 1 phr Hostanox PAR 24 instead of 2 phr tris(nonylphenyl) phosphite.

TABLE 4
Properties of comparative examples 1 to 4

| | Compara- | Compara- | Compara- | Compara- |
|---|---|---|---|---|
| | tive | tive | tive | tive |
| | example 1 | example 2 | example 3 | example 4 |
| Thickness [μm] | 100 | 90 | 85 | 85 |
| Force at break [N/cm] | 36 | 18 | 24 | ND |
| Elongation at break [%] | 330 | 150 | 280 | ND |
| Force at 1% elongation | 1.3 | 4.0 | 6 | ND |
| [N/cm] | | | | |
| Shrinkage [%] | 5.0 | 2.0 | 2.5 | ND |
| Hand tearability | — | + | ++ | ND |
| Bond strength to steel | 1.0 | 2.5 | 2.4 | ND |
| [N/cm] | | | | |
| Visual assessment | — | — | — | — |

ND = not determined

### Comparative Example 5

In the same way as in example 6, a carrier film is produced and is coated with an adhesion promoter coat and also with adhesive. Instead of Baerostab UBZ 731 X, however, Baerostab UBZ 639 is used. Ghosting is observed on the test paint.

### Comparative Example 6

In the same way as in example 6, a carrier film is produced and is coated with an adhesion promoter coat and also with adhesive. Instead of Baerostab UBZ 731×, however, Baerostab CT 9073 is used. Ghosting is observed on the test paint.

### Comparative Example 7

In the same way as in example 6, a carrier film is produced, but with addition of 3 phr tris(nonylphenyl) phosphite, and is coated with an adhesion promoter coat and also with adhesive. Following detachment of the adhesive tape from the paint, very severe ghosting is observed.

### Comparative Example 8

A specimen is produced in the same way as in example 6, but additionally with 1 phr Hostanox PAR 24. Following detachment of the adhesive tape from the paint, ghosting is observed.

TABLE 5
Properties of comparative examples 5 to 8

| | Compara- | Compara- | Compara- | Compara- |
|---|---|---|---|---|
| | tive | tive | tive | tive |
| | example 5 | example 6 | example 7 | example 8 |
| Thickness [μm] | 95 | 90 | 90 | 85 |
| Force at break [N/cm] | 19 | 18 | 19 | 17 |
| Elongation at break [%] | 220 | 200 | 230 | 235 |
| Force at 1% elongation | 6 | 5 | 6 | 6 |
| [N/cm] | | | | |
| Shrinkage [%] | 3.0 | 2.5 | 2.5 | 3.0 |
| Hand tearability | ++ | ++ | ++ | ++ |
| Bond strength to steel | 2.1 | 2.2 | 1.8 | 2.0 |
| [N/cm] | | | | |
| Visual assessment | — | — | — | — |

1. An adhesive masking tape comprising a PVC carrier material in web form and a coating of pressure-sensitive adhesive applied thereto on one side, wherein the carrier material comprises the following constituents:
a) a PVC polymer having a K value of 58 to 90, preferably 65 to 80,
b) 20 to 55 phr of polymer plasticizer, and
c) 0.2 to 8 phr, of a phosphite-free PVC stabilizer.

2. The adhesive masking tape according to claim 1, wherein the stabilizer is free from lead and cadmium.

3. The adhesive masking tape according to claim 1, wherein the stabilizer is based on calcium and zinc.

4. The adhesive masking tape according to claim 1, wherein the PVC carrier material has a polymer plasticizer content of 15 to 35 phr.

5. The adhesive masking tape according to claim 1, wherein the polymer plasticizer is a polyester of phthalic acid, of azelaic acid, of sebacic acid adipic acid.

6. The adhesive masking tape according to claim 1, wherein the PVC carrier material comprises at least one phenolic.

7. The adhesive masking tape according to claim 1, wherein the total amount of plasticizing components in the PVC carrier material is 25 to 40 phr.

8. The adhesive masking tape according to claim 1, wherein
a) the tensile force at 1% elongation is at least 3 N/cm,
b) the tensile strength is 12 to 30 N/cm and/or
c) the elongation at break is in the range from 200% to 350%.

9. The adhesive masking tape according to claim 1, wherein for producing the PVC carrier material in web form, the constituents of the carrier material are mixed continuously and the mixture is shaped to a film on a calender.

10. The adhesive masking tape according to claim 1, wherein
a) the coating of pressure-sensitive adhesive comprises polyisoprene, polyisobutylene or polyacrylate and/or
b) the bond strength is in the range from 1.6 to 4.8 N/cm.

11. The adhesive masking tape according to claim 1, wherein the coating of pressure-sensitive adhesive is crosslinked or thermally crosslinkable or in application at up to 160° C. a residue-free removal, is possible.

12. A method of masking in a finishing of vehicles or vehicle parts, the method comprising:
masking tape according to claim 1; and covering a surface of a vehicle or vehicle part with the masking tape.

13. The method according to claim 12, wherein the PVC carrier material is produced in web form by a step of continuously mixing the constituents of the carrier material to form a mixture and a step of the shaping the mixture into a film on a calender.

14. The adhesive masking tape according to claim 1, wherein PVC carrier material has a phosphate-free PVC stabilizer content of 1 to 5 phr.

15. The adhesive masking tape according to claim 2, wherein the phosphate-free PVC stabilizer is free from tin.

16. The adhesive masking tape according to claim 1, wherein the PVC carrier material has a polymer plasticizer content of 25 to 35 phr.

17. The adhesive masking tape according to claim 6, wherein the at least one phenolic comprises a sulfur-free antioxidant.

18. The adhesive masking tape according to claim 7, wherein the plasticizing components comprise polymer plasticizer, monomer plasticizer, soft and PVC miscible polymer, and the soft component in a graft polymer.

19. The adhesive masking tape according to claim 1, wherein adhesive masking tape has a thickness below 130 μm.

20. The adhesive masking tape according to claim 18, wherein the thickness of the adhesive masking tape is below 100 μm.
